(19) United States
(12) Patent Application Publication
(10) Pub. No.: US 2009/0083641 A1
(43) Pub. Date: Mar. 26, 2009

(54) WEB CONTENT MANAGEMENT SYSTEM INVOLVING CERTAIN ELEMENTS AS CONTENT

(75) Inventor: Alex H. Christy, Peoria, IL (US)

Correspondence Address: LEYDIG, VOIT & MAYER, LTD, TWO PRUDENTIAL PLAZA SUITE 4900, 180 N. STETSON AVE, CHICAGO, IL, 60601, US

(73) Assignee: CATERPILLAR INC., Peoria, IL (US)

(21) Appl. No.: 11/860,175

(22) Filed: Sep. 24, 2007

(51) Int. Cl. G06F 3/00

(52) U.S. Cl. 715/760

(57) ABSTRACT

A system and method for users to easily create and maintain web sites provides web content management and administration though graphical user interfaces in which certain web site elements are treated as content. This enables easier control of the content and design of web sites to make to maintain a common look and feel among related sites, and to make it easier to maintain a commonality of content.

### TECHNICAL FIELD

The present disclosure relates generally to systems and methods for managing and administering web sites, and more particularly, to systems and methods for managing web sites by treating certain elements of a web site as content.

### BACKGROUND

Many large organizations such as corporate entities and the like provide a multiplicity of web sites to the public and internally throughout the organization. These enterprises are often heterogeneous, both physically and logically. For example, they may involve different business or organization units that span diverse areas of expertise. For these and other practical reasons, smaller functional or operational groups within an organization often use different web sites to communicate unique information. Some information, however, may be worthy of inclusion on more than one of the organization's websites. Additionally, large organizations often require large numbers of personnel to have responsibility for content on the web sites. Thus, the ability to create web sites and to update and maintain them without significant training requirements, and to allow for centralized sharing and administration of multiple web sites within an enterprise is useful.

The processes and methods for creating, editing, storing, organizing and/or publishing web content in an organization is known as Content Management. Some Content Management tools attempt to group these processes in large, monolithic architectures. In many instances, these approaches require the organization to adopt proprietary languages and environments that are managed by skilled personnel.

Other existing software for management of corporate web sites, however, uses a conglomeration of unrelated tools to manage different elements of the sites. Many of the tools are written in different programming languages, have a different look and feel from one another, and are distributed differently across the organization. Some management approaches attempt to break apart interdependencies among functional groups as well as the interdependencies among content creators, administrators, and web developers. While such a separation may provide the group members an amount of freedom to be more autonomous by focusing only on their section, they often result in multiple smaller “homogeneous” sites within the organization that are unrelated to each other. It is therefore desirable to provide adequate systems and methods for managing the content and other elements of web sites on an enterprise scale, while at the same time providing a solution that is easy to implement and use.

### BRIEF SUMMARY

This disclosure relates to, in one aspect, a system and method that enables ready creation and maintenance of web sites. As explained below, web content management refers to the practice of controlling the content and design of web sites to make it easier to maintain a common look and feel among related sites, and to make it easier to maintain a commonality of content. The system and method according to this disclosure consolidates multiple web management tools into a relatively unified user interface. This unified user interface eases the burden of learning the system each time a developer desires to update a site within the organization.

Through the use of taxonomy, the present disclosure provides a structured way of organizing and categorizing content. Content is stored once and can be reused on any other of the enterprise's external web sites, or on internal portals. It allows basic web sites to be easily created and maintained without prior knowledge, experience, or formal training in web site design, HTML coding, or JavaScript programming. When content is modified, it is modified everywhere that piece of content is displayed. Corporate standards (look and feel, proper web content, etc.) are more easily followed. Content is secured properly. Each site is equipped with a preview web site that replicates their production site allowing for easy editing.

### BRIEF DESCRIPTION OF THE DRAWINGS

FIG. 1 is a block diagram representation of a system for managing web sites according to the disclosure.

FIG. 2 is an exemplary display of a graphical user interface for administering a web site according to the disclosure.

FIG. 3 is an exemplary screen display of a graphical user interface for managing web site content according to the disclosure.

FIGS. 4-5 are exemplary screen displays of a graphical user interface for creating content according to the disclosure.

FIG. 6 is an exemplary screen display of a graphical user interface for alerting a user with search results according to the disclosure.

FIG. 7 is a flow diagram of a method for managing content to be displayed on a web site.

### DETAILED DESCRIPTION

This disclosure relates to a system and method for managing the elements of web sites, such as those created or developed within an organization. Elements within the system, including menus and layout, are treated as content. Thus, tools that are typically used to manage content are also used to manage other elements, including the other elements' security settings and other metadata. The system presents an interactive graphical user interface that enables users to manage the properties of web site elements in a logical and uniform fashion across organization groups. Specifically, the graphical user interface presents a web page with a one or more user-selectable options, along with a working area corresponding to a selected option in which associated web site elements can readily be manipulated.

As referred to herein, web site content can be articles, images or graphics, web links, and documents (such as a Microsoft Word, PowerPoint, or Excel document). A web content management system provides a mechanism to create and store content centrally so it can be used and reused repeatedly. Thus, the same piece of content can be used for multiple web sites and on portals, while residing in a single location. Such content can also be managed with workflow so that it can get the appropriate approvals, and follow retention guidelines.

The disclosed system and method allow creation of content, such as articles and managed files that are then made available for use on a corporate web site. A managed file is any type of file such as a Microsoft Word document or PowerPoint presentation, a PDF file, or a JPG or GIF graphic, among others. The system and method further allow management of existing content by viewing, editing, submitting, and launching existing content. Additionally, the system and method allow use of built-in search capabilities to locate content available to launch a corporate web site, and it allows the setting of alerts to notify users when certain events (such as modification of content) occur.

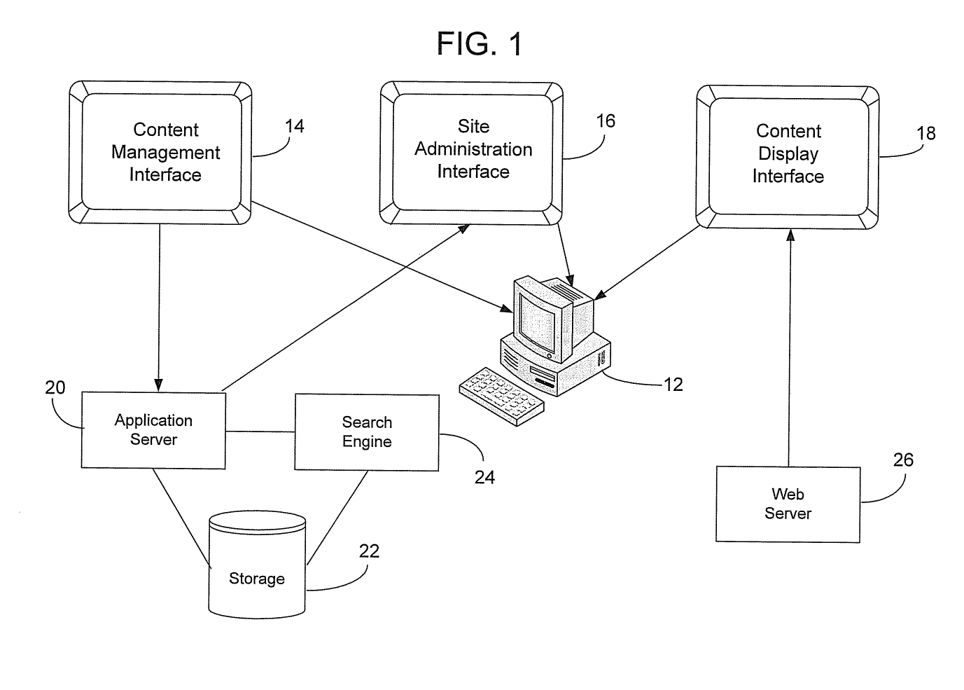

FIG. 1 illustrates a computing system 10 for managing and administering web sites within an organization. The system preferably permits interaction with users, disposed at a user computer 12, through a single user interface. However, three separate interfaces are herein described as any one or more of these interfaces may be presented to the user at a given time. The first interface is a content management interface 14, used to create and maintain the content on a site. The second interface is a site administrator interface 16, used to setup and maintain those items that have to do with the site as a whole, such as menus, freestanding layouts, authorized users of the site and aliases. The third interface is a content display interface 18, which is essentially the web site itself. As explained in greater detail below, one or more of these interfaces is presented to a user in order to manage or administer a web site.

The user interfaces are preferably provided to the user computer 12 from a central application server 20. Specifically, the central application server 20 accesses one or more appropriate interface elements located in storage 22 via a search engine 24. As explained in greater detail below, the application server 20 operates in a logical fashion to pass requests to the search engine 24 for locating content pieces as desired. In addition, a web server 26 is communicatively coupled with the user computer 12. The web server 26 has the capability to serve web content in response to requests from the user computer 12. In this way, the web server 26 provides web content that is ultimately to be displayed. Those skilled in the art will appreciate that the configuration illustrated in FIG. 1 is illustrative only. Instead of the web server 26 serving content to the user computer 12, content may alternatively, or additionally, be provided from the application server 20 or from other computing devices.

Disclosed embodiments make use of taxonomy to standardize web site attributes across multiple corporate web sites within an enterprise. These attributes are preferably used to categorize the subject matter of particular web site information. By using taxonomies, the system and method conserves resources and eliminates duplicative efforts. Moreover, searching across corporate web sites is easier due to similar structures and attribute settings, as is site profiling, filtering, and pushing of information. The management and administration system described herein allows users to ‘tag’ web site elements, including content and menu components, with particular attribute settings according to a desired taxonomy. Users can save attribute settings as preferences, so that they may be re-used in later tagging operations when applying similar taxonomies.

In a preferred embodiment, system users are granted any of a variety of levels of access, as determined through use of the site administrator interface. These user access levels define particular functional roles and permissions. By way of example, an embodiment provides the following user access roles: Author (who can create content for a site); Editor (who can create and launch content); Translator (who can translate a site for use in a foreign country); and Site Administrator (who can perform all organization and maintenance functions for a site). Additional sub-site administrator roles may be determined with limited access to portions of the management and administration system.

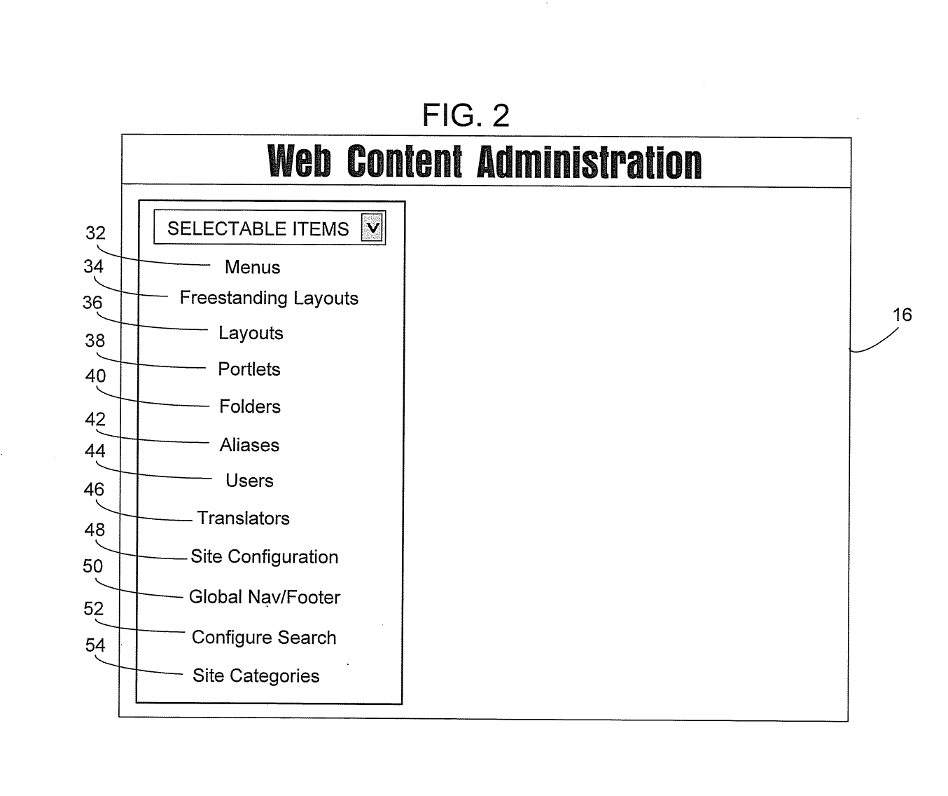

FIG. 2 illustrates an exemplary site administration interface 16 for administering a corporate web site. As shown in FIG. 1, the application server 20 in one embodiment creates the site administration interface 16 through access to web elements stored on the storage device 22. In this embodiment, the administration interface 16 presents the user with one or more selectable options to choose an element with which to work. This selectable element may be in the form of an entry in a drop-down menu, whereby the user selects the menu element corresponding to the element to be administered. Alternatively, the user-available options may be presented in various other forms such as by providing elements in the form of a list associated with controls and/or cues from which to select. Exemplary selectable elements include those set forth below.

A selectable Menus element 32 can be used to open a display screen that enables the user to define various attributes of content that will be created. For example, the user can add navigational menu elements, determine web page layout, and add filtering criteria for each of the components in a page layout.

A Freestanding Layouts element 34 is selected by the user, for example, to open a display screen that enable the user to add or change pages within the site that are not connected to a menu.

A Layouts element 36 can be selected, for example, to open a display screen that enables the user to add a layout to the site.

A Portlets element 38 is selectable in the drop-down menu to access a further display screen that enables the user to add or change portlet information for internal sites within the organization.

A Folders element 40 is selectable, for example, to access a display screen that enables the user to add or change project folders used to organize content.

An Aliases element 42 is selectable, for example, to access a display screen that enables the user to add or change aliases to menus. In this way, the user can modify existing menus as desired.

A Users element 44 is selectable by the user, for example, to access a display screen that enables the user to add or change privileges of authors, editors, translators and site administrators.

A Translators element 46 is selectable, for example, to access a display screen that enables the user to add or change translators.

A Site Configuration element 48 is selectable, for example, to access a further display screen that enables the user to provide basic site information such as site administrator and a “Contact Us” e-mail address and specify filter metadata for the site.

A Global Nav/Footer element 50 is selectable by the user, for example, to access a further display screen that enables the user to add navigational links to the top of the page (header) and/or to the bottom of the page (footer).

A Configure Search element 52 is selectable by the user, for example, to configure the Basic and Advanced Search pages and decide whether the Advanced Search link will be displayed on the page to be created.

Finally, FIG. 2 illustrates a Site Categories element 54 that is selectable by the user, for example, to add or change site-specific categories used to classify content; site categories are preferably defined by the site administrator, and map to the site's navigational menus.

Notably, each of these elements is treated by the content management and administration system as “content”. Thus, any metadata that could typically be associated with content on a web site can similarly be associated with Menus, Layouts, or even Users. Such metadata can include keywords and descriptions that can be used for later searching.

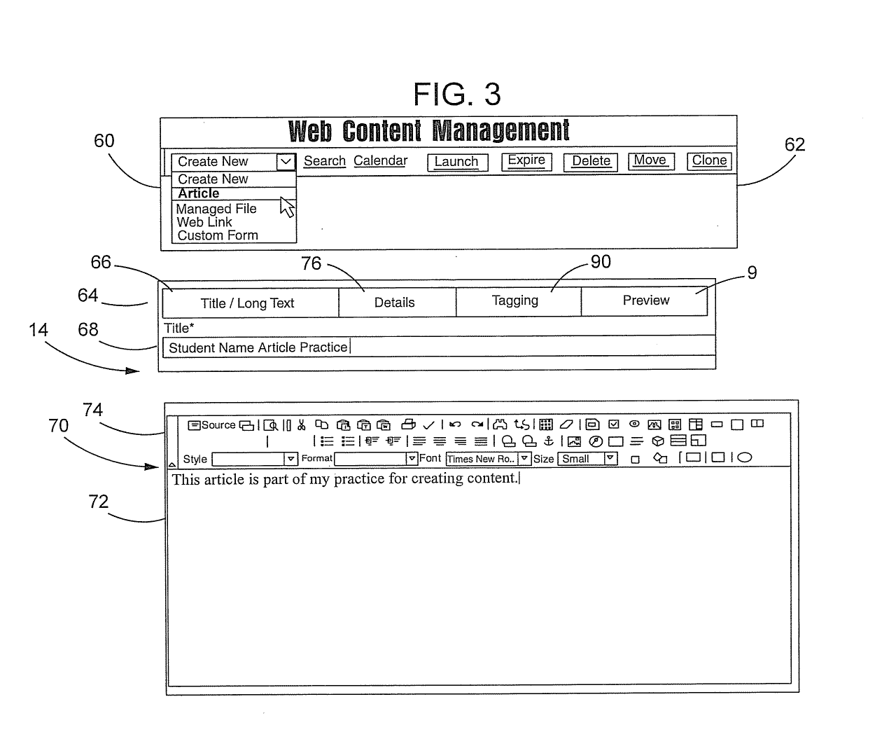

FIG. 3 illustrates an exemplary content management interface, such as the content management interface 14 shown in FIG. 1, for managing the content of a corporate web site. The user is presented with one or more selectable options to choose an element with which to work. Such options may be presented in the form of menus such as a drop-down menu 60, whereby the user selects the menu element corresponding to the particular element to be managed. The elements presented in the menu 60 may be the same as the elements in the menu of the administration interface 16 of FIG. 2. In a preferred embodiment, however, only certain elements are made available to users of the content management interface 14. The particular available elements are a function of the user's authorized level of access in this example. In particular, a Create New content element is presented via a drop-down menu 60 in a display area 62 to users who have authorization to create new content, but do not possess administrative privileges.

Upon choosing the Create New content element via the display area 62, a user is presented with additional content related options. A first option is for creation of content, such as articles. As shown in FIG. 2, other selectable elements in the drop-down menu 60 include a selectable Managed File for creating a managed file, a Web Link element for creating a web link associated with the content and a Custom Form element for creating a customizable form for use within the organization.

FIGS. 3-6 illustrate an example in which the user may create an article using a content management system similar to the system described herein. After selecting “Create New” content from the first drop-down menu of elements 60 in a first display area 62, the user selects “Create New Article” from a drop-down of the menu 60 shown in FIG. 3, prompting four tabs to appear in a screen display area 64 shown in FIG. 3. A “Title/Long Text” tab 66 permits the user to enter the article's title in a title field 68. In addition, appropriate selection of the Title/Long Text tab 66 presents a text editor portion 70. The latter text editor portion 70 of the content management interface 14 permits entry of article text in a text editor window 72. In the illustrated embodiment, the text editor portion 70 further includes a tool bar 74 for providing word processing functions and actions to aid the text entry process.

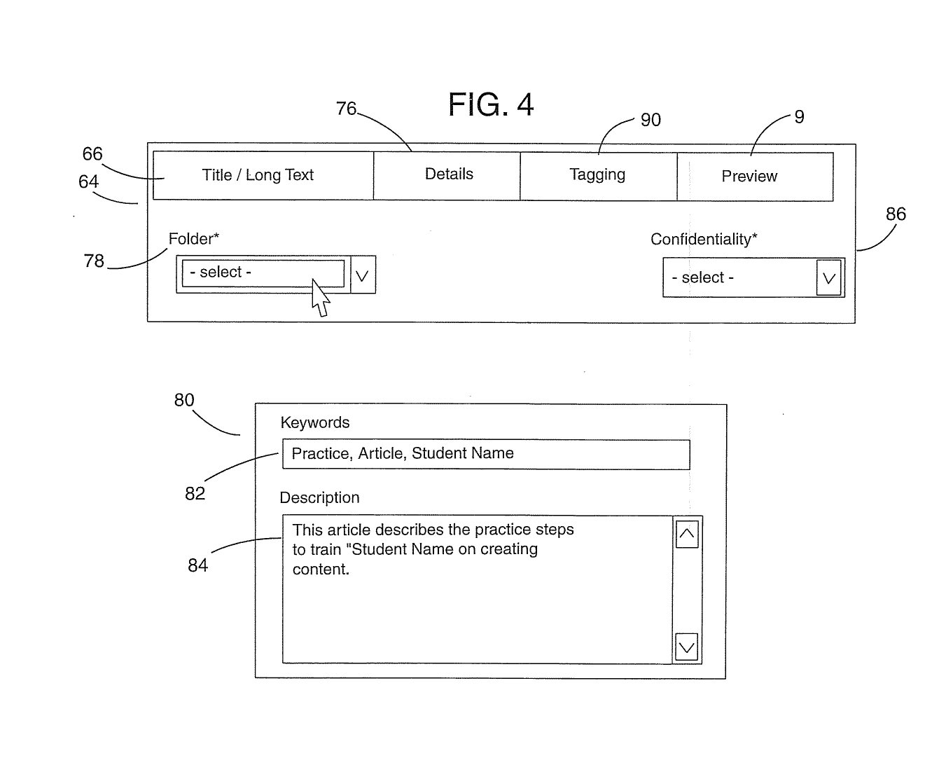

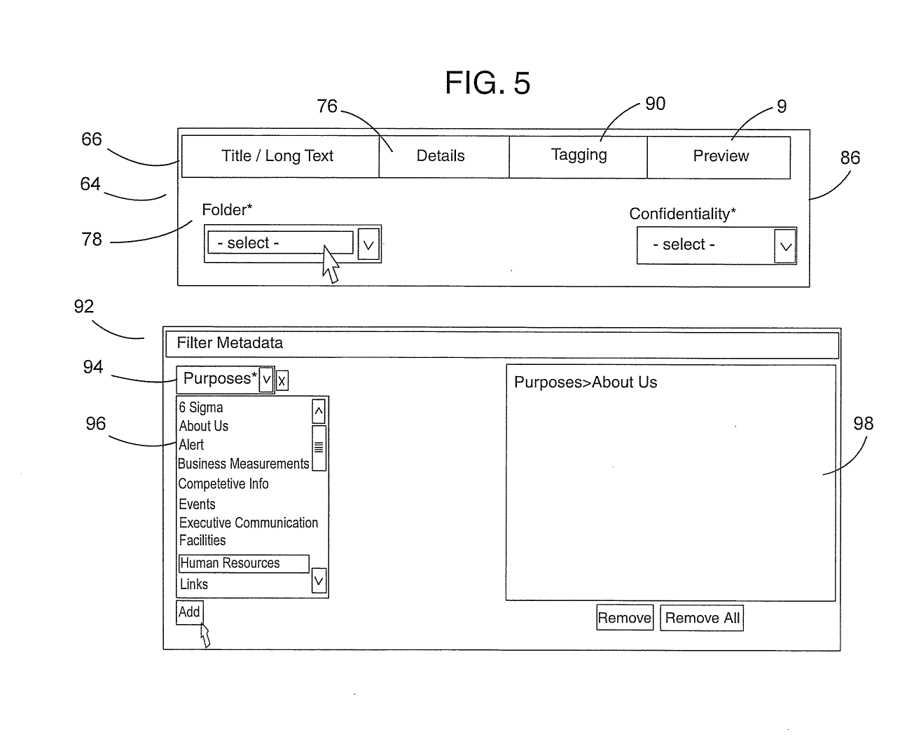

The screen display area 64 shown in FIGS. 3-5 further includes a “Details” tab 76 that permits the user to select a folder 78 (FIGS. 4-5) in which the content is to be placed. Selection of the Details tab 76 also causes a Keywords/Description window 80 to be presented. The latter window 80 permits the user to assign the content with keywords through entry of the same into a Keywords field 82. In addition, the window 80 presents a Description field 84 that permits entry of a description of the article being created. An owner for the content is also assigned using the Details tab to invoke presentation of appropriate fields and/or menus, and images may be added to the article as well. Other details concerning the created content may be included by the user, such as confidentiality levels by way of a Confidentiality drop-down menu 86. In addition, effective dates for the article (e.g., when it should start and stop being made available), and whether the article should be made available for others' web sites via sharing tools. Because the system treats all website elements as content, similar tabs are presented to the user for selection when creating, for example, managed content or web links.

Once content has been created, it can be edited and managed through the content management system. An exemplary listing of content related information that can be managed includes the following: ID (a unique number assigned to each piece of content); Title (the name assigned to a piece of content); Type (the content type (managed file, article, web link, etc.)); Current Site (defines whether the content is part of the current site. If marked ‘N’ the content was shared from another site); Modified (the date a piece of content was last modified); Working State (the state of the content (draft or ready to launch)); Launched (states whether a piece of content is live or not); Author (the person who last modified a piece of content); Content Owner (the person who owns the content); and Translator (the person who translates a piece of content).

Additionally, a user may choose from a variety of options as to how a content inventory is displayed (e.g., by owner, launching within a given timeframe, etc.), when particular content should launch, and other options. These controls are shown as “Launch,” “Expire,” “Delete,” “Move,” and “Clone” presented in the display area 62 of the web content management interface 14. Other controls may also be presented to the user for management of the created content. Such controls invoke appropriate functions and actions for managing the content.

An Inline Editor is further provided to allow for ease of editing content. By using the inline editor, a preview of the content is displayed via the content display interface, as it would appear in a production environment. The content may be edited directly in this preview area, avoiding the need to open an additional editing tool.

Embodiments also allow users to create preferences. Preferences are useful for repeated uses of the content management system. Exemplary preference choices include whether or not the built-in editor should be used, identification of frequently used searches, and email alerts upon the occurrence of certain actions. Additionally, preferences allow for the pre-population of fields with particular information, such as Content Information, Filter Metadata and Security Metadata.

As previously noted, searching may be based on the assigned metadata to elements of the website. Because the system treats all elements equally as content, menus and layouts may be searched as easily as traditional content (e.g., articles). For creating metadata that the user desires to be tracked, a “Tagging” tab 90 is presented to the user. As shown in FIG. 5, selection of the Tagging tab 90 causes a “Filter Metadata” display area 92 to be presented to the user. This enables desired filter criteria to be associated with other content characteristics that are likely to be relevant to an organization. In the illustrated embodiment, selection of a desired Filter criteria in a drop-down menu 94 and of a filter characteristic from the list of items presented in a list 96, enables the user to create metadata associations. These are placed in an Association window 98, where they can be modified as desired by the user.

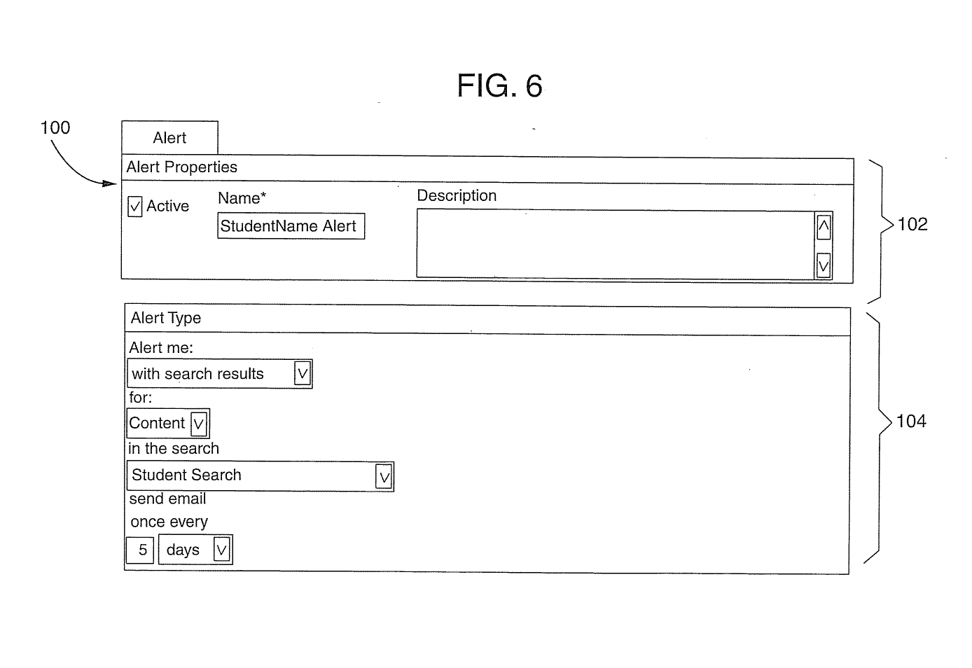

An Alert functionality allows for email alerts to content creators or other users who desire such alerts when specific actions are performed in the content management system. For example, a user can choose to be alerted whenever someone launches content he owns. A user can also, for example, choose to have a saved search performed periodically, with the results emailed to him. This enables automated tracking of content that is of specific interest. As shown in FIG. 6, an Alert display window 100 is presented to the user upon selection of an Alert item in the filter characteristic list 96 shown in the Filter Metadata display area 92. Specifically, the Alert display window 100 includes entry fields corresponding to alert properties provided in an Alert Properties display area 102. These include whether the Alert is active, the Alert name, and a description field. The Alert window 100 further includes an Alert Type display area 104. The latter display area permits entry of the type of Alert to be generated along with the frequency.

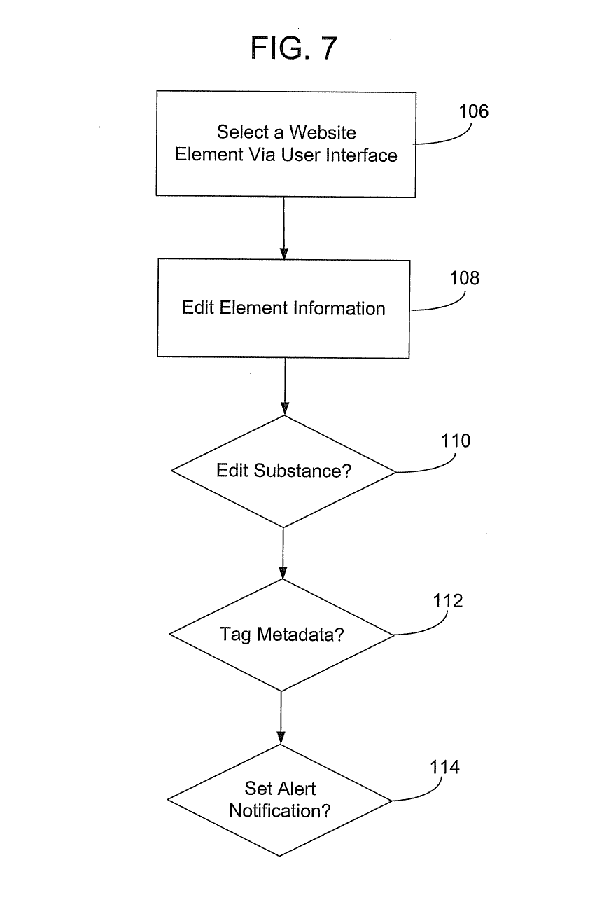

Turning to FIG. 7, a flow diagram is described illustrating a method for managing content on a website, in accordance with an embodiment. At step 106, a website element is selected via a user interface. As described above, the website element may be traditional content, menus, layout, or other typical components of a website. The user interface then allows for editing of relevant element information at step 108. The user preferably has the option at step 110 of editing the substance of the element itself, such as via an in-line WYSIWYG editor. The user additionally preferably has the option of tagging the element with metadata at step 112, such metadata describing the element and its properties. The user also preferably has the option of setting an alert notification at step 114, to allow the user to be notified if the element is accessed, changed, deleted, or operated on in other manners. Additional editing options are allowable via the user interface. Furthermore, embodiments need not present such options in a linear or sequential fashion, but rather allow for the user to edit various types of element information in any particular order to the user's liking.

### INDUSTRIAL APPLICABILITY

The industrial applicability of the web site management and administration system and method described herein will be readily appreciated from the foregoing discussion. The disclosed system and method may be particularly suitable for use in large organizations in which it is often difficult to implement standard web content management and web site administration methodologies across diverse business units. However, the disclosed system and method may be used in any environment in which such management and administration is desirable. In such deployments, the disclosed method and system provides several advantages over previously existing systems for content management. In particular, it gives users the ability to create and manage content at their discretion. Also, users have greater ability to track and monitor the use of created content, and to create a “look and feel” that is relatively uniform across an organization.

The present disclosure therefore allows management and administration of web sites that is easily scalable across large organizations. The management is scalable horizontally, even though the web sites of one group may be written differently from web sites in another group. In addition, global operations, such as global search/replace operations may be performed across a variety of elements of web sites, not merely what has traditionally been considered “content”. The web site management and administration system and method also permit vertical scalability as several different elements, such as menus, layouts, or the like, are managed in similar fashion and without specially dedicated software tools, as is the case with current web site management and administration methodologies.

It will be appreciated that the foregoing description provides examples of the disclosed system and technique. However, it is contemplated that other implementations of the disclosure may differ in detail from the foregoing examples. For example, the particular screen displays set forth in FIGS. 3 through 9 are shown for illustrative purposes only. The functionality and presentation of the various user-selectable options may be presented in any number of ways, so long as a hierarchical relationship is maintained. All references to the disclosure or examples thereof are intended to reference the particular example being discussed at that point and are not intended to imply any limitation as to the scope of the disclosure more generally. Any language of distinction and disparagement with respect to certain features is intended to indicate a lack of preference for those features, but not to exclude such from the scope of the disclosure entirely unless otherwise indicated. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A graphical user interface for managing characteristics of a plurality of elements used to display content on a web site, the user interface comprising:
a user-selectable option for selecting one of the plurality of elements; and
a working area for manipulating characteristics of the selected element;
wherein the plurality of elements comprises:
content;
menus; and
layout.

2. The graphical user interface of claim 1 wherein the plurality of elements further comprises folders and aliases.

3. The graphical user interface of claim 1 further comprising a second user-selectable option for toggling an inline editor, whereby content on the web site is presented for manipulation in the working area.

4. The graphical user interface of claim 1 further comprising a second user-selectable option for searching across content and other elements, wherein the other elements include menus.

5. The graphical user interface of claim 1 further comprising a second user-selectable option for assigning metadata to a selected element.

6. A system for managing content of a web site comprising:
a first graphical user interface for managing characteristics of a plurality of elements to be used in displaying content on the web site;
a storage device for storing content and other elements for display on the web site; and
a web server for retrieving requested content from the storage device;
wherein the plurality of elements comprises:
content;
menus; and
layout.

7. The system of claim 6 further comprising a second graphical user interface for administering non-content related information pertaining to the web site.

8. The system of claim 6 further comprising a search engine for searching across content and other elements on the storage device, wherein the other elements include menus.

9. A method of managing content to be displayed on a web site, comprising:
selecting one of a plurality of available web site elements via a graphical user interface; and
editing information associated with the selected element in a working area presented via the graphical user interface;
wherein the plurality of elements comprises:
content;
menus; and
layout.

10. The method of claim 9 wherein manipulating the information comprises setting an alert to notify when the selected element is subsequently accessed or modified.

11. The method of claim 10 wherein the selected element is menus.

12. The method of claim 9 further comprising applying a preference of element settings to the web site from settings stored with respect to a second web site.
